(19) United States
(12) Patent Application Publication
(10) Pub. No.: US 2025/0346010 A1
(43) Pub. Date: Nov. 13, 2025

(54) DEVICE FOR INSERTING AT LEAST ONE OBJECT INTO AT LEAST ONE DIE OF A TABLETTING MACHINE

(71) Applicant: Korsch AG, Berlin (DE)

(72) Inventor: Thomas WEIßBACH, Berlin (DE)

(73) Assignee: Korsch AG, Berlin (DE)

(21) Appl. No.: 18/866,877

(22) PCT Filed: May 16, 2023
(86) PCT No.: PCT/EP2023/063113

§ 371 Date: Nov. 18, 2024

(30) Foreign Application Priority Data
May 18, 2022 (EP) 22174192.9

(51) Int. Cl. B30B 11/34; B30B 15/30

(52) U.S. Cl. CPC B30B 11/34; B30B 15/30

(57) ABSTRACT

The invention relates to an apparatus for inserting at least one object into at least one die of a tableting machine, in which the at least one die is arranged on a reference circle in a turret driven to rotate about a first axis of rotation. The apparatus comprises a second turret that can rotate about a second axis of rotation. The second turret also exhibits at least one object holder, wherein the at least one object holder comprises holding means which enable the at least one object to be picked up, transported and released. The movement path of the at least one object can be controlled radially and tangentially in relation to the rotational movement of the second turret via the at least one object holder, such that the movement path of the at least one object can imitate the movement path of the at least one die, at least over an angular range of rotation of the second turret.

The invention relates to an apparatus for inserting at least one object into at least one die of a tableting machine, in which the at least one die is arranged on a reference circle in a turret driven to rotate about a first axis of rotation. The apparatus comprises a second turret that can rotate about a second axis of rotation. The second turret also exhibits at least one object holder, wherein the at least one object holder comprises holding means which enable the at least one object to be picked up, transported and released. The movement path of the at least one object can be controlled radially and tangentially in relation to the rotational movement of the second turret via the at least one object holder, such that the movement path of the at least one object can imitate the movement path of the at least one die, at least over an angular range of rotation of the second turret.

The invention also relates to a system comprising a tableting machine and the apparatus described above.

### BACKGROUND AND PRIOR ART

The invention lies in the field of tableting machines, in particular rotary tableting machines, which are used in the pharmaceutical, technical or chemical industry or in the food industry to produce large quantities of tablets or pellets from powdered materials.

It is known that rotary tableting machines have a turret which carries a plurality of pairs of punches, each pair of punches being formed by an upper punch and a lower punch which are adjustable relative to one another. The turret comprises a die table in which die openings are provided at regular intervals on a reference circle, which have sleeve-shaped inserts known as dies. The material to be pressed is filled into these dies or die openings by means of a filling device.

When a pair of punches enters the area of the filled die or die opening as a result of the rotation of the turret, the two punches are moved towards each other by control cams and enter the area of a compression roller station. In the compression roller station, the punches are pressed against each other so that the material in the die opening is compacted into a tablet, for example. Once the pressing process is complete, both punches are moved upwards and the tablet is ejected from the die opening or the die. The compression force is transferred to the compression tooling by means of compression rollers. The compression tooling is also referred to as upper and lower punches.

It is also known to provide single or multi-layer tablets with a core or an object, so-called inserts. These cores or objects are fed individually to the dies and pressed into or coated by a medium to be pressed, in particular powder. It is crucial for the production of such tablets or pellets on a rotary tableting machine that the cores or objects are fed individually and in a defined manner to a die such that they can be placed in a desired position, which is advantageously centered in the die.

In this respect, there are solutions with rotating insertion devices in which the circular paths of the dies and the insertion device partially overlap and therefore intersect at exactly two points. With the help of a complex (and error-prone) control system, the aim is to eject the object to be inserted as rapidly as possible at exactly one of the intersection points. The publications DE 10 2013 104 344 A1 and DE 10 2009 002 450 A1, for example, disclose such rotating insertion devices, wherein cores are picked up by gripper arms from a transfer wheel and inserted into the dies.

Furthermore, solutions with rotating insertion devices are known from the prior art, for example from DE 38 19 821 C2, in which gripper arms are arranged to move radially on the turret of the insertion device and are therefore able to follow the curved path of the dies over a limited angle of rotation by means of a cam control or engagement on the turret. However, this results in a difference in the path speeds of the inserter and the dies, such that actual synchronous running is not possible despite the tracked path of the gripper arm, but the position of the inserted object is largely determined by the time of ejection.

DE 40 25 484 C1 also discloses an insertion device integrated into the turret of the rotary tableting machine. In particular, radial arms are arranged directly on the driving turret of the rotary tableting machine above the die table and rotate in synchronization with the dies assigned to them. The radial arms are also (radially) retractable and extendable in the turret and can pick up objects and transfer them to the dies. Although such an insertion device enables a small construction volume and precise and reproducible positioning of the objects within the die, this comparatively complex design regularly leads to malfunctions. In addition, conventional rotary tableting machines cannot easily be retrofitted with such an insertion device.

It is also known from DE 103 21 754 B4 to position cores or objects on a continuous conveyor and to guide the continuous conveyor over a reference circle of the turret of the tablet press and to push them into the dies by means of the upper punches of the tablet press. However, carrying the cores or objects over a reference circle of the turret disadvantageously entails complex measures for positioning the cores or objects and synchronizing the movement of the cores or objects and the dies.

DE 38 19 821 A discloses a rotary tablet press comprising a rotary-driven die table and a transfer device. A plurality of head parts with transfer heads are mounted on radial arms on the transfer device, which are firmly screwed to the turret. The transfer heads have suction pipes and vacuum devices for receiving and releasing the cores. The radial arms consist of vertical and horizontal cylinder-piston units that can be actuated independently of each other. The cores are conveyed to the receiving stars of the transfer device via a feed device. The radial arm moves downwards by means of the vertical cylinder pistons and the transfer head picks up the core by means of negative pressure. The horizontal cylinder pistons then move radially outwards and as soon as the die is reached, the head part opens into the head receiving recesses of a guide ring of the die table, such that the head guide ring mechanically guides the transfer head in a force-controlled manner and the reference circles of the die table and the transfer device thus overlap. DE 38 19 821 A discloses in particular a radial controllability of the transfer heads. The core is thereby placed in the die and pressed with powder. By pressing the core into the die, the core is inserted in a centered position without moving radially. Synchronization of the movement paths of the dies with the movement path of the transfer heads is achieved in particular by the interlocking of head receiving recesses of a head guide ring of the die table with head parts or the transfer heads. Due to radial mobility and engagement on the turret, the head parts or transfer heads should follow the curved path of the dies over a limited angle of rotation. However, there is room for improvement with regard to the precision of the positioning of the core.

JP 2019 135062 A further discloses a compression device comprising a conveyor belt, a feeding device and a tableting machine. The conveyor belt preferably transports electronic chips to the feed device, which transports them to the tablet press. There, the chips are inserted into dies and pressed with powder. The feeding device is designed as a closed loop, the shape of which is adapted to the radius of the dies in a transfer area. A plurality of gripping devices are attached to the feeder, which have movable gripper fingers for picking up and releasing the chips. The closing and opening of the gripper fingers is mechanically force-controlled by means of corresponding guide cams. The feeding device or gripping devices are driven by the rotary movement of the turret of the tablet press. A toothed wheel transmission is provided for this purpose, the teeth of which engage in the upper rollers of the gripping device.

With regard to the known solutions, there is therefore a need for improvement in terms of positioning accuracy and performance (speed), while at the same time the possibility of dispensing with a complex control system and reducing susceptibility to faults would be desirable.

### OBJECTIVE OF THE INVENTION

The objective of the invention is therefore to eliminate the disadvantages of the prior art and to provide an apparatus for inserting at least one object into at least one die of a tableting machine, which enables accurate or precise insertion of the at least one object with a continuously rotating turret of the tableting machine, wherein a high level of repeatability and reliability are achieved even at high turret speeds.

### SUMMARY OF THE INVENTION

The objective according to the invention is solved by the features of the independent claims. Advantageous embodiments of the invention are described in the dependent claims.

In a preferred embodiment, the invention relates to an apparatus for inserting at least one object into at least one die of a tableting machine, in which the at least one die is arranged on a reference circle in a turret driven to rotate about a first axis of rotation;
wherein the apparatus comprises a second turret rotatable about a second axis of rotation;
wherein the second turret comprises at least one object holder, wherein the at least one object holder comprises holding means which enable the at least one object to be picked up, transported and released;
   characterized in that the movement path of the at least one object can be controlled radially and tangentially in relation to the rotational movement of the second turret via the at least one object holder, such that the movement path of the at least one object can imitate the movement path of the at least one die, at least over an angular range of rotation of the second turret.

In particular, the apparatus according to the invention enables objects to be separated, picked up and precisely inserted into the dies of a rotary tableting machine with a continuously rotating turret. Contrary to the prior art, the proposed apparatus enables the movement path of an object advantageously to overlap the movement path of a die over a large time range during the insertion process, wherein the object can in particular also be moved synchronously with the die. In other words, the movement paths overlap over a longer distance instead of mainly at two points, as was previously the case. The fact that the object can advantageously be guided synchronously with the die means that the object can be inserted into the die at any point along the overlapping path. The positioning accuracy is therefore less dependent on the time of insertion or release of the object. Among other things, this leads to a higher degree of repeat accuracy and reliability at high speeds.

Although, as described above, insertion devices are known that allow radial movement of the object in relation to the rotary movement of the turret comprised in the insertion device, whereby the movement paths of an object and a die can also overlap over a distance, this leads to a difference in the path speeds of the object and die. Synchronous operation is therefore not possible. It has been shown that the tangential controllability of the object in relation to the rotary movement of the second turret, in addition to the radial controllability of the object, can overcome this problem. By controlling the object tangentially, the path speed of the object can advantageously be continuously adjusted such that the object can be moved synchronously with the die.

Advantageously, conventional rotary tableting machines, which are configured in particular to press single-layer or multi-layer tablets, can be extended in a simple manner with the apparatus according to the invention, so that these can press a core or an object into the pellets to be produced. It is understood that at least one die is arranged on a reference circle in a turret driven to rotate about a first axis of rotation within the rotary tableting machine, while the apparatus comprises a second turret which rotates about a second axis of rotation.

In a preferred embodiment, the axis of rotation of the first turret (i.e. the turret of the tableting machine) is arranged substantially parallel to the axis of rotation of the second turret (i.e. the turret of the apparatus according to the invention). In this respect, the second turret can advantageously be subsequently positioned in such a way that the apparatus according to the invention is able to insert the at least one object into the at least one die. The apparatus according to the invention can thus preferably be provided as an additional module for rotary tableting machines and preferably only needs to be adjusted once. For this purpose, the apparatus according to the invention is preferably to be moved radially onto the turret of the tableting machine until the object holder or the object is aligned approximately on the reference circle on which the dies are arranged. The apparatus according to the invention is advantageously “robust” with regard to tolerances in positioning. Furthermore, an additional device for separating the objects to be inserted is also no longer required; this function is covered by the proposed apparatus.

For the purposes of the invention, a turret is preferably a rotating component which rotates about an axis of rotation such that components fixed to the turret move on a circular path. The at least one die is preferably present on a reference circle in a turret driven to rotate about a first axis of rotation. Accordingly, the die rotates on a circular path around the axis of rotation of the first turret. The movement path of the die is therefore preferably circular. The object, on the other hand, is held by the object holder, which in turn is mounted on the second turret. Accordingly, the object rotates around the second axis of rotation and would also preferably move on a circular path without radial and tangential controllability of the object holder or object.

In insertion devices of the prior art, which comprise a turret but no radial and tangential controllability of the object holder or object, the intersection points of both circular paths (object/die) would now be selected in order to “eject” the object into the die. In this context, the inventors have recognized that this procedure does not allow the objects to be deposited accurately. By contrast, since the object can be controlled radially and tangentially in relation to the rotational movement of the second turret via the object holder, the movement path of the object can be adapted so that it matches the movement path of the dies, wherein the object can also be moved synchronously with the die.

Preferably, the adaptation of the movement path by the object takes place in a range between the (hypothetical) intersection points that would occur if the object could not be controlled radially and tangentially. This range can be described by a rotation angle of the second turret, i.e. an angular range of rotation of the second turret.

The movement path of the objects is therefore adapted to the path of the dies via a tangential and radial movement of the individual object holders in relation to the rotary movement of the second turret, which follows a circular path. At the points at which the object holders are connected to the second turret, they therefore preferably also move on a circular path. However, due to the radial and tangential controllability of the individual object holders, this circular movement path can be adapted for the objects held by the holding means, such that the object can also move synchronously with the die.

From JP 2019 135062 A cited above, an adaptation of a movement of objects on a die path is also known. However, this takes place via an insertion device which, instead of a second turret, comprises a feed device which is set up as a closed but non-circular loop. In JP 2019 135062, the feed device is also referred to as a rounded triangle, with a lower side adapted to the shape of the die table. The gripping devices of JP 2019 135062, which are installed on the feed device, therefore do not themselves move on a circular path. However, the provision of such a feed device is more complex and requires a greater distance between the gripping devices provided on the feed device. The solution according to the invention, in which a second turret is used, but in which the movement path of the objects can be controlled radially and tangentially in relation to the rotary movement of the second turret via the individual object holders, is simpler in design and allows a denser arrangement of object holders. In addition to a more robust design of the apparatus, production efficiency can also be increased.

In a preferred embodiment, the rotation angle range of the second turret is preferably a movement section of the second turret, i.e. a rotational movement that the turret performs over a certain rotation angle. The angular range of rotation of the second turret, in which the movement path of the object can imitate the movement path of the die by means of a tangential and radial deflection of the object holder, is preferably in an angular range of rotation <180°. In this way, the movement path of the die is imitated by the object over a maximum of half a rotation of the second turret.

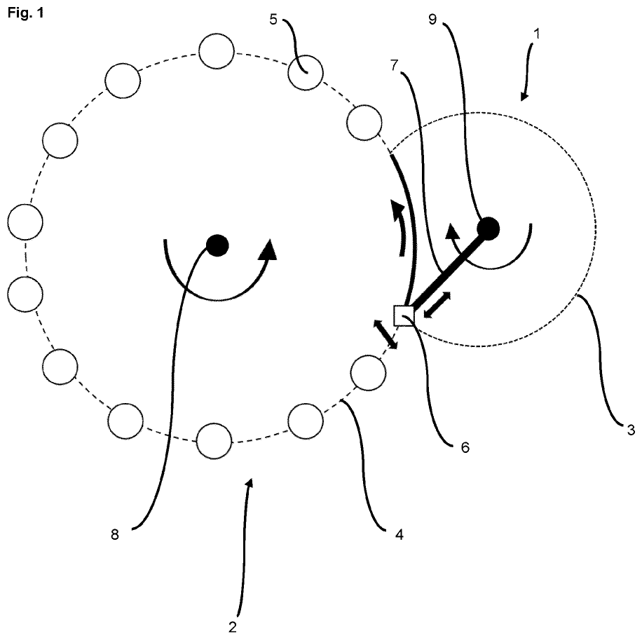

For example, the movement path of the object runs on a circular path in an angular range of rotation of the second turret of around 340°. As soon as the object encounters the movement path of the die, the movement path of the object changes radially and tangentially (in relation to the rotation of the second turret) and adapts to the movement path of the die, wherein the object can be moved synchronously with the die. In the example described, the movement path of the object can now follow the movement path of the die over an angular range of rotation of approximately 20° of the second turret. (see also FIG. 1)

The imitation or adaptation of the movement path is preferably configured in such a way that the movement paths of the object and the die overlap over a certain time and distance range, wherein the object moves synchronously with the die. In this context, the center and/or the center of gravity of the object is preferably distanced at a height from the die located approximately on the longitudinal axis of the die. It is understood that the height can vary when the object is inserted. During this (relatively long) synchronous movement, the object can be inserted by lowering the object holder. It is not necessary to position the object by dropping it as rapidly as possible at a specific point.

For the purposes of the invention, an object is preferably a three-dimensional object which has a size and geometric configuration which makes it possible to embed the object in a pellet, the volume of the pellet being dependent on the die, the material and the compression force. An object can accordingly be regarded as a core of the pellet. Preferably, the core is configured as a fixed component, wherein the core consists, for example, of a different material or material composition than the material of the rest of the pellet. The object or the core can also be pre-compacted powdered material. Such pellets with a core are also referred to as core tablets. In a further preferred embodiment, the object (as such) exhibits a liquid and/or gaseous medium which is enclosed by a solid shell. For example, in relation to coated core tablets, this may be a liquid active ingredient which is encased in a solid that is digestible by a human.

There are no limits to the configuration of the object as long as it can be inserted into the die of a tableting machine, in particular a rotary tableting machine, and compressed with powdered material. In another preferred embodiment, the object can also be configured as a microchip. According to more recent technical developments, microchips can be compressed into tablets as cores and serve as an aid for remote diagnosis after the patient has taken the corresponding tablet. The apparatus according to the invention is advantageously capable of inserting very small microchips as objects into the dies of a tableting machine, whereby “smart” tablets can be produced. In particular, tablets with microchips in them, which can be less than 1 mm thick, for example, can transmit a confirmation signal to a receiver outside the patient's body about the ingestion of the tablet, including the time of ingestion, thereby enabling monitoring.

Preferably, the object exhibits a volume that allows the object to be embedded in a pellet in a conventional rotary tableting machine. The object is preferably about 1 mm-30 mm in its largest dimension and preferably about 0.1 mm-10 mm in its smallest dimension. The object is not limited to these dimension values.

Furthermore, the second turret preferably comprises at least one object holder. The object holder preferably rotates with the second turret and is able to pick up an object from an object reservoir. The object holder can then transport the object over a substantially half rotation of the second turret and finally, preferably, release the object into the at least one die. The object holder and the at least one die as well as the two turrets are coordinated in such a way (in particular via the radial and tangential controllability of the object or object holder) that the object can be inserted into the die in a precise position. The object reservoir can be configured as a container or also comprise a feed system, such as a conveyor belt and/or a transfer wheel. With respect to the second turret, the object reservoir is preferably located approximately on the opposite side of the location at which the object is introduced into the at least one die, such that the object holder holds or transports the object over approximately a 180° rotation of the second turret. The object holder is preferably configured to pick up an object individually and provide it to the at least one die.

In a further preferred embodiment, the object holder exhibits a holding means which is preferably configured to pick up, hold and/or release the object. The holding means is preferably configured to hold the object for transportation over approximately half a rotation of the second turret and to release it into the at least one die in a region in which the movement path of the object intersects the movement path of the die. Preferably, the holding means can be activated/controlled sufficiently quickly to be able to pick up a fixed-position object even at high rotational speeds of the second turret. It is also preferable that the holding means can, for example, apply or release a holding force within a few milliseconds, so that the object can be picked up from the object reservoir or released into the die without any disadvantageous latency.

In a further preferred embodiment, the apparatus is characterized in that the second turret comprises a coupling element which is configured as follows,
to initiate and/or ensure a rotary movement of the second turret via an active contact with the driving first turret;
to mechanically force-control the movement path of the at least one object by means of the at least one object holder at least over an angular range of rotation of the second turret.

The presence of a coupling element entails particular advantages. The coupling element advantageously combines two functions in one component, namely a) ensuring or initiating a rotary movement of the second turret and b) influencing the movement path of the object. The fact that the coupling element is preferably in active contact with the driving first turret (which ensures a rotational movement of the second turret) means that the apparatus according to the invention advantageously does not need its own drive. Among other things, a complex synchronization of the drives of the apparatus and the tableting machine is therefore not necessary. Dispensing with a separate drive also results in a particularly lightweight and therefore easy-to-transport apparatus for inserting objects into a die, which can be used flexibly, particularly in different tableting machines. Furthermore, as the coupling element is simultaneously configured to mechanically force-control the movement path of the object via the object holder, a complex control arrangement of the object holder can be dispensed with. It goes without saying that the number of components used is also reduced.

For the purposes of the invention, a coupling element is a component or an assembly which establishes a connection in the broadest sense between two components (here: for example, between the first and second turret). The coupling element can preferably be in (temporary) mechanical contact with both components and create a mechanical connection. Preferably, the connection can also be contactless, wherein only an effect is transmitted, for example a magnet can influence another component without a mechanical connection being established. In particular, it is preferably an active connection, wherein the coupling element is preferably in active contact with the components. The coupling element thus enables interaction between two components (mechanical or otherwise). In order to ensure a rotary movement of the second turret, the coupling element is preferably in active contact with the first turret, wherein the first turret is included in the tableting machine and represents a drive. The active contact is achieved, for example, by mechanically engaging the coupling element with elements of the first turret. The coupling element can, for example, also take the form of a transmission with elements such as toothed wheels, cam elements, connecting rods, rod links, belts, chains, etc. (without being limited to these), which transmits the rotational movement of the first turret to the second turret.

As soon as the first turret starts to rotate, a force is preferably transmitted to the coupling element, which in turn transmits the force to the second turret. This advantageously ensures that the second turret also performs a rotational movement. The coupling element is preferably configured in such a way that little energy is lost through friction or deformation. The second turret can thus be set in a rotary motion via the coupling element and also maintain this rotary motion as long as the first turret of the tableting machine is rotating.

Furthermore, the coupling element is preferably configured to force-control the movement path of the at least one object via the object holder. In this respect, the coupling element exhibits means that preferably establish a mechanical, hydraulic and/or electrical link between the coupling element and the object holder. The coupling element can influence the object holder via this link and, in particular, manipulate the movement path of the at least one object.

In a further preferred embodiment, the apparatus is characterized in that the at least one object holder is actively connected to the coupling element via a guide mechanism, wherein the coupling element can receive a coupling movement through the active contact with the first turret and the movement path of the at least one object can be deflected radially and tangentially in relation to the rotational movement of the second turret via the at least one object holder and the guide mechanism in a predetermined spatial direction, namely in the form of the coupling movement. Such a configuration, in particular via a guide mechanism, makes it possible to provide an effective and efficient apparatus with few components, which can control the movement path of the object. Through the guide mechanism, a movement of the coupling element, namely a coupling movement, directly influences the movement path of the object via the object holder.

The guide mechanism establishes an interaction between the first turret on which the at least one die is arranged and the movement path of the object via the coupling element.

Preferably, the coupling element can assume a coupling movement, which is imposed on the coupling element by the active contact, such as engagement, with the first turret. Due to the guide mechanism, the coupling movement preferably has a direct influence on the object holder and thus on the movement path of the object. In particular, the coupling element preferably determines the movement of the object holder and, correspondingly, the object with its movement. For example, the coupling element can undergo a tangential and/or radial deflection, wherein this deflection assumes a spatial direction which is transmitted directly—i.e. simultaneously—to the object holder.

For the purposes of the invention, a guide mechanism is a component or assembly that is set up to transmit forces and control the object holder or the object on a movement path. In particular, the guide mechanism can transmit the coupling movement of the coupling element to the object holder, whereby the movement path of the object can be influenced. The guiding mechanism can preferably comprise hydraulic, pneumatic, electrical and/or mechanical components (without being limited to these).

In a further preferred embodiment, the apparatus is characterized in that the coupling element comprises a rod-shaped coupling member with a coupling head, wherein the coupling member is mounted on one side in the second turret, wherein the coupling member is aligned such that the coupling head points radially outwards and is structurally adapted to a component of the first turret, whereby the coupling head can engage with the component of the first turret, such that a rotary movement of the first turret can be transmitted. This configuration of the coupling element is particularly simple in its design. The apparatus preferably exhibits a plurality of coupling elements or coupling members that interact synergistically and can set the second turret in rotation by engaging with components of the first turret. Each coupling element is preferably in temporary active contact with the first turret by mechanically picking up a component of the first turret over an angular range of rotation, e.g. from about 10° to 30°, during the rotation of the second turret. As a result of engagement with a coupling element, a force is transmitted to the second turret, which rotates the second turret by a certain amount. The coupling elements preferably come into active contact with components of the first turret one after the other, such that each interaction between component and coupling element exerts a certain force on the second turret.

In a preferred embodiment, the coupling element comprises a rod-shaped coupling member. A rod-shaped coupling member is particularly advantageous to use because, on the one hand, it is very suitable for transmitting forces with as little loss as possible and, on the other hand, if it is mounted on one side in two degrees of freedom as proposed (tangentially pivotable and radially displaceable), it enables particularly uniform engagement. The coupling element has a relatively high rigidity and is preferably made of a metal or a fiber-reinforced plastic. It is also preferable to use rod-shaped coupling elements that are adjustable in length. The adjustability allows the apparatus according to the invention to be used variably for a plurality of different tableting machines, in particular with turrets of different sizes, and to be adapted to different machine-specific requirements.

According to the invention, a coupling head is a component which is arranged as an end piece on the coupling member.

In a preferred embodiment, the coupling member and the coupling head are preferably produced as an inseparable unit from a single component. In this context, the coupling member and the coupling head are on the one hand made of a material with particularly high rigidity in order to be able to transmit forces and torques without major losses, and on the other hand preferably at least the surface is soft/elastic enough so that no major wear occurs to the tableting machine when the component of the turret is engaged with. Preferably, the coupling member and coupling head are made of a fiber-reinforced plastic.

In a further preferred embodiment, the coupling head can also be detachably connected to the coupling element such that it can be exchanged in the tableting machine, depending on the component to be gripped, and the apparatus according to the invention can thus be used for different tableting machines. Furthermore, this also makes it particularly easy to replace worn coupling heads without having to replace the entire coupling element. In particular, the coupling head can exhibit a different type of material than the coupling element. A suitable material pairing between the coupling head and the component to be picked up in the tableting machine makes it possible to provide particularly durable coupling elements. For example, the coupling head can comprise particularly elastic material, which results in little wear when engaging with the component of the tableting machine, while the coupling element, on the other hand, is designed to be particularly rigid in order to be able to transmit movements and forces advantageously.

Preferably, the component to be picked up by the coupling element is an element mounted on the turret of the tableting machine. Accordingly, the component preferably rotates around the axis of the turret on a circular path.

In a further preferred embodiment, the apparatus is characterized in that the coupling head comprises a fork, which is preferably matched to the diameter of a shank of a lower punch of the first turret, such that the fork can accommodate the shank of the lower punch. The configuration of the coupling head as a fork makes it particularly advantageous to receive and transmit forces in the radial and tangential directions (in relation to the rotation of the second turret). In particular, the forces received in the tangential direction create a torque that acts on the second turret and advantageously drives it.

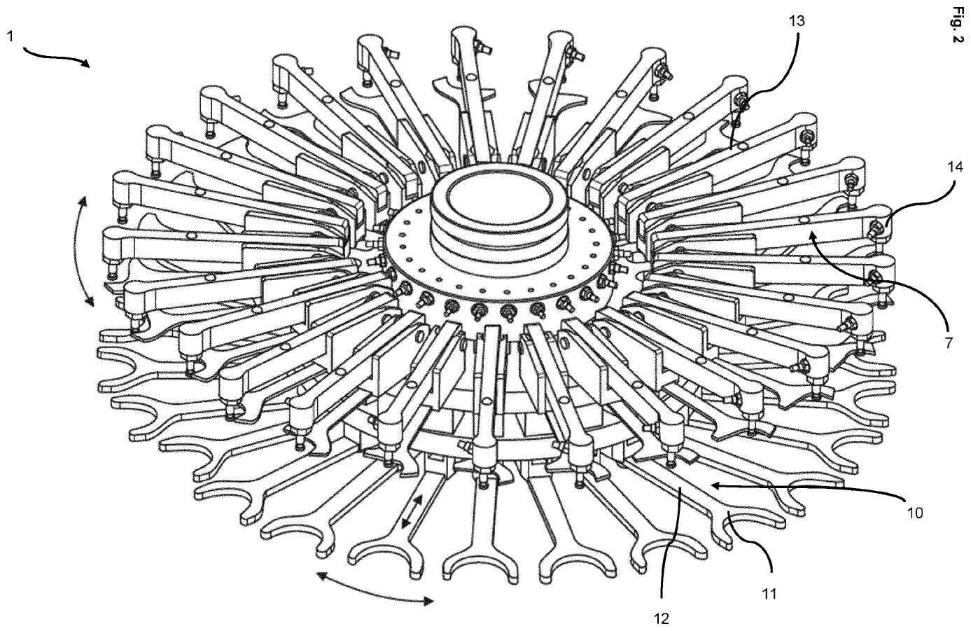

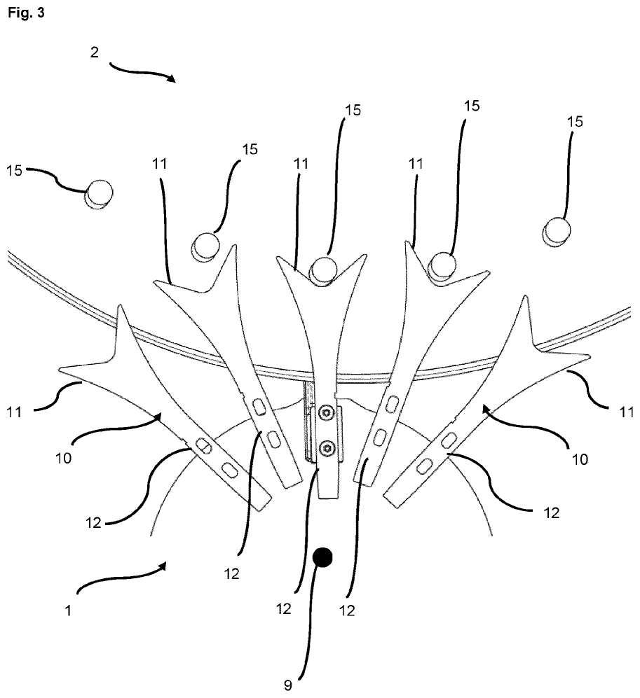

For the purposes of the invention, the fork is preferably a component which comprises a rod-shaped element with extensions at one end. Preferably, the fork exhibits two extensions which are spaced apart from one another in such a way that a shank of a lower punch can be accommodated. In a figurative sense, the fork can exhibit the configuration of a carving fork, wherein the extensions or prongs are spaced apart approximately as far as the diameter of a shank of the lower punch. (see also FIG. 2 or FIG. 3)

In a further preferred embodiment, the apparatus is characterized in that the object holder comprises a gripper arm with a holding element, which is mounted radially in the second turret, the holding element preferably being configured to hold the object in the manner of a positive connection and/or frictional connection. The use of a gripper arm is particularly suitable for inserting an object into a die, as this can be used in combination with a plurality of other gripper arms, wherein sufficient freedom of movement, in particular for tangential deflection of the object or pivoting of the gripper arm, can still be ensured by spacing the respective gripper arms.

In a preferred embodiment, the gripper arm is a substantially rod-shaped component which is preferably mounted radially in the second turret and at the end of which facing away from the turret the holding element is arranged. By means of the guide mechanism mentioned above, the gripper arm is preferably influenced by a coupling movement of the coupling element or coupling member, wherein the coupling movement in particular determines the radial displacement and the pivotability of the gripper arm.

For the purposes of the invention, the holding element can be regarded as a preferred embodiment of the holding means. The holding element is preferably configured to hold the object in the manner of a positive connection and/or frictional connection. In this context, the holding element preferably comprises mechanical, pneumatic, electropneumatic, hydraulic, electrical and/or magnetic components. Accordingly, the holding element can be configured, for example, in such a way that it exhibits a pincer that holds the object in a frictionally connected manner. Alternatively, the holding element can exhibit means that generate negative pressure and thus hold the object in a frictionally connected manner. In this context, the gripper arm is preferably configured in such a way that it itself or, in particular, the holding element can be adjusted in a height position so that the holding element can precisely pick up and/or place the at least one object.

In a further preferred embodiment, the apparatus is characterized in that the gripper arm is mechanically connected to the coupling element, preferably a coupling member, in such a way that a tangential and radial deflection of the coupling element, preferably the coupling member, in relation to a rotary movement of the second turret can be transmitted directly to the gripper arm. In particular, the direct transmission of the deflection—i.e. without latency—entails particularly good synchronization of the gripper arm or the movement path of the object and the at least one die or its movement path.

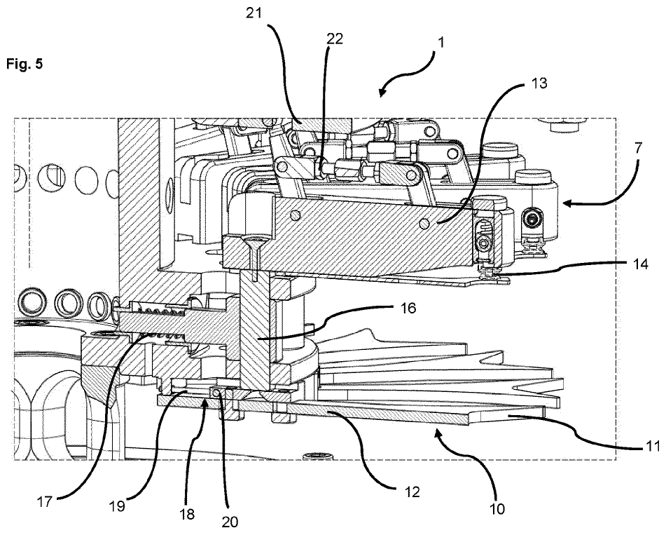

In a preferred embodiment, the mechanical connection of the gripper arm and coupling element or coupling member preferably comprises a bolt in this respect, which is oriented substantially orthogonally to the gripper arm and coupling member, which are preferably aligned horizontally and mounted radially in the second turret. The bolt is used in particular to transfer forces from the coupling member to the gripper arm such that the movement of the coupling member can be adapted by the gripper arm. The bolt is preferably rigidly connected to the gripper arm and the coupling element. (see FIG. 5)

In a further preferred embodiment, the apparatus is characterized in that the second turret comprises guide cams which are configured to guide the holding means comprised in the object holder in a height position. The guide curves are preferably arranged circumferentially on the second turret such that the holding means (or preferably also the holding element) is force-controlled or guided along this guide cam. Guide cams of this type are also known, for example, in rotary tableting machines for guiding upper and lower punches.

In a further preferred embodiment, the holding element comprised in the gripper arm can be guided in a height position by guide cams on the second turret.

In a further preferred embodiment, the apparatus is characterized in that the object holder and the coupling element are resiliently mounted in the second turret and can be guided into a radial starting position in relation to the rotation of the second turret via a spring preload, while the object holder and the coupling element can be pivoted tangentially in relation to the rotation of the second turret in the radial starting position, preferably pivoted at an angle of up to 2°. Preferably, the object holder and the coupling element are rod-shaped and accordingly mounted on one side in the second turret. Starting from the center of the second turret, the rod-shaped element can now be pivoted such that the ends of the object holder or the coupling element perform an approximately tangential movement in relation to the rotational movement of the second turret. Pivoting the coupling element by up to about 2° is particularly advantageous in terms of uniform engagement while maintaining sufficiently efficient power transmission from the turret of the tableting machine (first turret) to the turret of the apparatus (second turret).

In the radial starting position, the object holder and the coupling element are preferably pushed out radially as far as possible and remain guided in this starting position by the spring preload. Since the object holder and the coupling element can be pivoted tangentially in this position, it is advantageously possible to pick up a rotating component of the tablet machine evenly by first pivoting the coupling element when receiving the component, preferably by 2°, and only then applying the force to the coupling element that drives the second turret.

Furthermore, the resilient mounting enables, in particular, a smooth and non-jerky movement of the object holder and the coupling element, which means, among other things, that the object can be held particularly securely by the holding means or holding element.

In a further preferred embodiment, the apparatus is characterized in that the object holder and the coupling element can be transferred to a pick-up position when the coupling element is in active contact with the first turret,
wherein the coupling member and the gripper arm have the greatest possible radial deflection and tangential mobility in the starting position, whereas the radial deflection and the tangential mobility in the gripping position can continuously decrease to a minimum over an angular range of rotation of the second turret and then increase again to the radial starting position and the greatest possible tangential mobility.

The advantage of such an embodiment is that, in particular, the coupling element or the coupling member can reach a pick-up position from the starting position in a simplified manner. Due to the fact that the coupling element or coupling member has a tangential mobility relative to the rotation of the second turret in the starting position, wherein the tangential mobility preferably relates to the end piece of the coupling member, there is a certain amount of play, such that the coupling element or coupling member does not have to be brought exactly to the component to be picked up (e.g. lower punch).

The gripper arm comprised in the object holder preferably performs the same radial and tangential movement as the coupling member at the same time. This simplifies the design of the present apparatus in particular, since on the one hand a simple mechanical guide mechanism enables this movement of the gripper arm and on the other hand at the same time this exploits the fact that the component to be picked up, preferably the lower punch, already specifies the exact position of the die. As is known, the lower punch is arranged in the turret of the tableting machine in such a way that it is inserted into the die from below in a centered position.

For the purposes of the invention, a pick-up position is defined as the position or also position sequence of the object holder or the coupling element which is assumed by both apparatus elements when the coupling member is in active contact with the first turret, preferably during the phase when the coupling member or the coupling head contacts the lower punch of the tableting machine. The pick-up position can also be referred to as the pick-up phase, as the pick-up position can be changed continuously, with the pick-up position preferably prevailing over the entire angular range of rotation in which the object synchronously crosses the movement path of the die. In the course of the pick-up position, the coupling element preferably comes into contact with a rotating component of the tableting machine. The turret of the tableting machine (first turret) preferably rotates in the opposite direction to the turret of the apparatus according to the invention (second turret). As soon as the component, preferably the lower punch, comes into contact with the coupling member or the coupling head, the coupling member is entrained, wherein during entrainment the component or the lower punch presses the coupling member radially against the axis of rotation of the second turret until the coupling member reaches a minimum radial deflection. It is understood that the object holder or the gripper arm performs the same tangential and radial movement. The proposed apparatus preferably exhibits a bearing for the coupling element which prevents or makes impossible the tangential movement in the minimum radial deflection. After the coupling member has reached the minimum radial deflection, the component of the tableting machine, preferably the lower punch, continues to rotate and continues to guide the coupling member. Meanwhile, the spring, which is preferably comprised in the bearing, pushes the coupling element back out of the minimum radial deflection towards the starting position, wherein the tangential mobility increases again.

In a further preferred embodiment, the apparatus is characterized in that the difference between the initial radial position and the minimum radial deflection is between approximately 1 mm and 30 mm, preferably approximately 5 mm and 20 mm. Advantageously, the differential values described have been found to be sufficient to reproduce the movement path of the object with respect to the at least one die of the tableting machine. In particular, the values of the radial deflection allow not only a flexible possibility of radial change, but also stable guidance.

The radial starting position and the minimum radial deflection preferably refer to the radial position of the object holder or the gripper arm or the object and/or to the position of the coupling element or the coupling member or the coupling head. The initial radial position describes the position of the aforementioned apparatus elements with the largest possible outward displacement, starting from the center of the second turret. The minimum deflection, on the other hand, describes the smallest possible radial displacement, starting from the center of the turret. In other words, the end pieces of the aforementioned apparatus elements exhibit a maximum distance from the center of the turret in the initial position, while the end pieces exhibit a minimum distance in the minimum radial deflection. Preferably, the difference between the two positions can be between about 1 mm and about 30 mm, more preferably between about 5 mm and about 20.

In a further preferred embodiment, the apparatus is characterized in that the coupling member, the gripper arm and the mechanical connection are mounted in the second turret via a first spring element and a second spring element, with the first spring element preferably representing the radial starting position, while the second spring element defines a tangential mobility via a rigidity. The first spring element can therefore also be referred to as a radial spring, while the second spring element is preferably a tangential spring. The provision of radial and tangential spring elements makes it possible, above all, to engage with a component of the tableting machine with particular curve accuracy. Furthermore, the springs allow the coupling element and gripper arm to return to their starting position due to the preload applied, such that further engagement is repeatedly possible after each revolution.

In a preferred embodiment, the first spring element is configured as a coil spring. Preferably, the coil spring engages in the mechanical connection such that the coupling element and the gripper arm are equally influenced by this spring. As the first spring is preferably preloaded, a force acts on the coupling element, the gripper arm and the mechanical connection in the direction of their initial positions. It is understood that the coil spring guides the coupling element, the gripper arm and the mechanical connection in an initial position. During engagement, a force is applied to the coil spring in a radial direction via the coupling member, such that it is compressed and the coupling member, the gripper arm and the mechanical connection are displaced radially in the direction of the turret center. Other preferred embodiments are also possible in which a pneumatic spring and/or a constant pressure system is used instead of a coil spring.

In another preferred embodiment, the second spring element is a bending rod or bending beam, which is mounted in one degree of freedom on one side in a sleeve element, which in turn is attached to the turret. The bending rod or bending beam is guided accordingly by the sleeve element. Preferably, the bending bar or bending beam is attached to the end of the coupling element facing the turret and can be (partially) pushed out of the sleeve element. In the radial starting position of the coupling element, the bending bar or bending beam is pushed out of the sleeve element as far as possible such that it is bent as soon as a bending moment acts on it. During engagement, the coupling element is subjected to a tangential force by the component of the tableting machine, preferably by the lower punch. This force generates a bending torque on the bending bar or bending beam and causes bending, whereby the coupling element can be pivoted tangentially. In addition, the coupling element is pressed radially into the sleeve element during the pick-up process, which makes bending more difficult, to the point where the bending bar is completely inserted into the sleeve element and bending is no longer possible. If the bending bar or bending beam can no longer be bent, tangential movement of the coupling element is also not possible. The tangential mobility is determined accordingly by the rigidity of the bending bar or bending beam. The more rigid the bending bar, the lower the tangential mobility in the starting position, or the more force must be applied to achieve the desired mobility.

In a further preferred embodiment, the second spring element is preferably a combination of a bending rod or bending beam and a sleeve element, wherein the sleeve element is preferably mounted in one degree of freedom on the bending rod or bending beam. Contrary to the aforementioned embodiment, the bending bar or bending beam is mounted immovably radially on the turret of the preferred apparatus, while the sleeve element is preferably fixed to the coupling member. Furthermore, the sleeve element can accommodate the bending bar or bending beam within itself and is accordingly guided movably over the bending bar or bending beam, such that, as in the aforementioned embodiment, bending of the bending bar or bending beam is made more difficult if the sleeve element accommodates the entire bending bar within itself (see FIG. 5)

In a further preferred embodiment, the apparatus is characterized in that an angular range of rotation of the second turret, in which the movement path of the at least one object can be controlled radially and tangentially with respect to the rotational movement of the second turret via the at least one object holder, is at least about 10°, preferably at least about 20°. The angular range of rotation is preferably defined by the intersection points of the movement path of the die with the movement path of the object. If this could not be controlled tangentially or radially, the object would rotate continuously in the starting position around the second axis of rotation. The stated angular ranges of rotation are already sufficient to control the object in such a way that it can be positioned accurately in the at least one die.

The values and parameters described and all other parameters in this document are preferably not exact parameters, but rather parameters that assume “approximately” these values or parameters.

Terms such as “substantially”, “around”, “about”, “approx.” etc. preferably describe a tolerance range of less than ±40%, preferably less than ±20%, particularly preferably less than ±10%, even more preferably less than ±5% and in particular less than ±1% and always include the exact value. “Similar” preferably describes quantities that are “approximately equal”. “Partial” preferably describes at least 5%, particularly preferably at least 10%, and especially at least 20%, in some cases at least 40%.

In a further preferred embodiment, the invention relates to a system comprising
a. a tableting machine comprising at least one die which is arranged on a reference circle in a turret driven to rotate about a first axis of rotation, and
b. an apparatus of the type described above for inserting at least one object into the at least one die of the tableting machine.

A person skilled in the art will recognize that the advantages, technical effects and preferred embodiments discussed in the context of the apparatus according to the invention apply analogously to the system according to the invention. Likewise, all advantages, technical effects and preferred embodiments described in the context of the system are transferable to the apparatus.

As already described in the context of the apparatus according to the invention, the gripper arms are preferably arranged in such a way that they can not only move up and down, but can also move both radially and tangentially to the rotational movement of the turret. The upward and downward movement is preferably force-controlled by cams. The radial and tangential movement of the gripper arm, on the other hand, is also force-controlled by mechanical engagement with the die or lower punch. This ensures that the die and the gripper arm move in a forcibly guided manner in uninterrupted synchronization with each other during mechanical engagement. When not engaged with the turret, the gripper arms are held in a defined position by means of springs. The same can apply analogously to the process of separating and picking up the objects to be inserted. In this way, a longer distance or time span is made available during which the pick-up or insertion can take place.

In a further preferred embodiment, the system is characterized in that
a. a coupling element of the second turret is in active contact with the driving first turret in order to initiate and/or ensure a rotary movement of the second turret;
b. the at least one object holder comprises holding means which enable the at least one object to be picked up, transported and released;
c. the movement path of the object overlaps with the movement path of the die, wherein the movement path of the at least one object can be controlled radially and tangentially in relation to the rotational movement of the second turret, such that the movement path of the at least one object imitates the movement path of the at least one die at least over an angular range of rotation of the second turret, and the object holder is configured to release the at least one object into the die.

In a further preferred embodiment, the system is characterized in that the coupling element comprises a rod-shaped coupling member with a fork-shaped coupling head and the object holder comprises a gripper arm with a holding element,
wherein the gripper arm and the coupling member are resiliently mounted in the second turret and can be guided into a radial starting position in relation to the rotation of the second turret via a spring preload, while the gripper arm and the coupling member are freely movable tangentially in relation to the rotation of the second turret in the radial starting position,
wherein the gripper arm and the coupling member can be moved into a pick-up position when the coupling member is in active contact with the first turret,
   wherein the coupling member and the gripper arm have the greatest possible radial deflection and tangential mobility in the starting position, whereas the radial deflection and the tangential mobility in the pick-up position can continuously decrease to a minimum over an angular range of rotation of the second turret and then increase again to the radial starting position and the greatest possible tangential mobility.

In a further preferred embodiment, the invention relates to a use of an apparatus of the type described above or a system according to the type described above for inserting at least one object into at least one die of a tableting machine. The use of the preferred apparatus and the preferred system for inserting objects is to be seen by a person skilled in the art as a departure from the prior art, in which devices are primarily used which can only produce a radial change in the movement path of an object.

### FIGURES

In the following, the invention will be explained in more detail with the aid of figures, without being limited to these.

### BRIEF DESCRIPTION OF THE FIGURES

FIG. 1 Schematic representation of the interaction between a preferred apparatus and a preferred tableting machine

FIG. 2 Three-dimensional view of a preferred embodiment of the apparatus according to the invention

FIG. 3 Further schematic representation of the interaction between a preferred apparatus and a tableting machine, in particular the representation of the interaction between preferred coupling elements and preferred shanks of lower punches

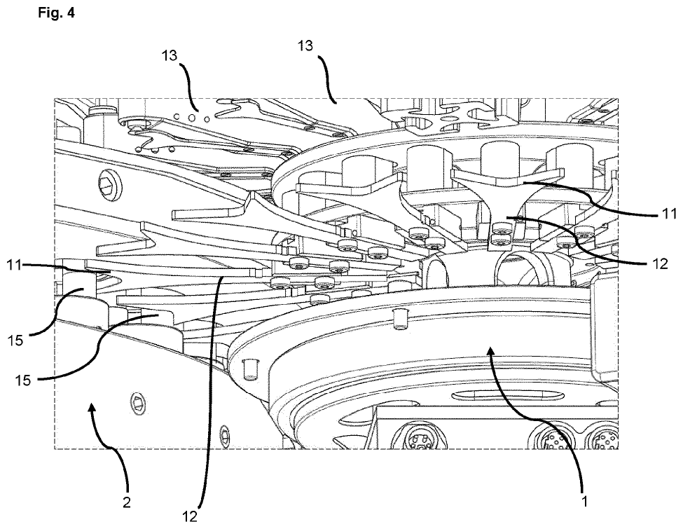

FIG. 4 Three-dimensional view of a section of a preferred embodiment of the apparatus according to the invention and of a preferred tableting machine

FIG. 5 Sectional view of a preferred embodiment of the apparatus according to the invention

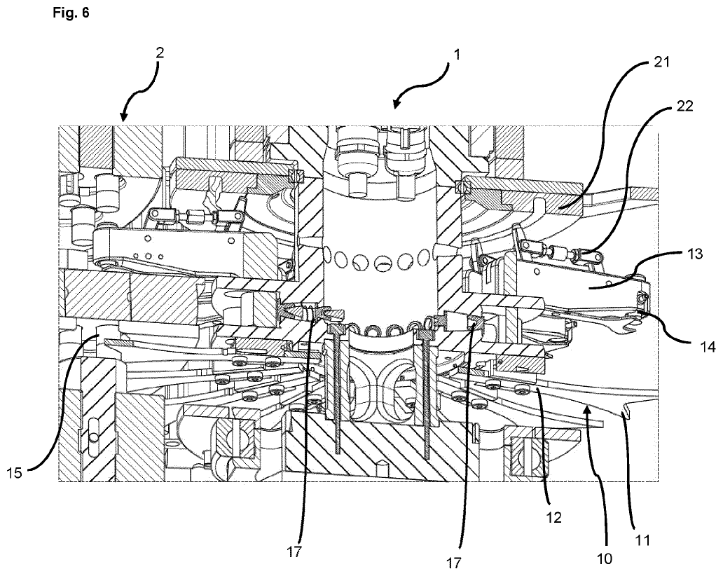

FIG. 6 Further sectional view of a preferred embodiment of the apparatus according to the invention

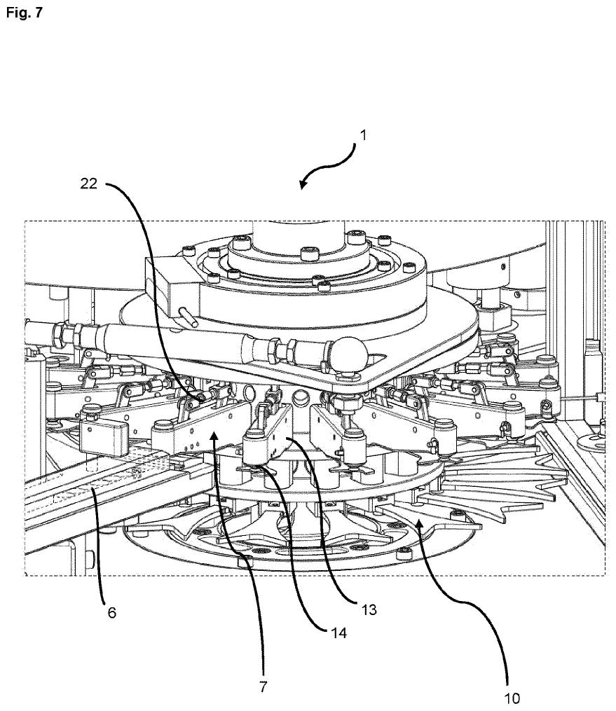

FIG. 7 Three-dimensional view of a preferred embodiment of the apparatus according to the invention, in particular a representation of the picking up of objects by preferred object holders

### DETAILED DESCRIPTION OF THE FIGURES

FIG. 1 shows a schematic representation of the interaction between the preferred apparatus 1 and a tableting machine 2. In particular, the preferred apparatus 1 is configured to insert at least one object 6 into at least one die 5 of the tableting machine 2. Within the tableting machine 2, the dies 5 are preferably arranged on a reference circle in a turret driven in rotation about a first axis of rotation 8. The apparatus 1, on the other hand, exhibits a second turret that can rotate about a second axis of rotation 9. The second turret comprises at least one object holder 7 with a holding means, such that it is possible to pick up, transport and release the at least one object 6. The object holder 7 with the holding means is preferably made up of a gripper arm 13 (shown in the other figures) and a holding element 14 (shown in the other figures). The gripper arm 13 is preferably mounted radially in the second turret, wherein the holding element 14 is preferably configured to hold the object in a positively and/or frictionally connected manner.

The movement path 3 of the at least one object 6 can be controlled radially and tangentially in relation to the rotational movement of the second turret via the at least one object holder 7 (radial and tangential movement of the object are shown by double arrows), such that the movement path 3 of the at least one object 6 can imitate the movement path 4 of the at least one die 5, at least over an angular range of rotation of the second turret.

FIG. 2 illustrates a three-dimensional view of a preferred embodiment of the apparatus 1 according to the invention. In particular, the apparatus 1 exhibits a turret (second turret) which comprises a plurality of object holders 7. The object holders 7 are preferably each actively connected to a coupling element 10. In addition, an object holder 7 preferably comprises a gripper arm 13 with a holding element 14. The gripper arm 13 is mounted radially in the turret of the preferred apparatus 1, wherein the holding element 14 is preferably set up to hold the object 6 (not shown in FIG. 2) in a positively and/or frictionally connected manner. A coupling element 10, on the other hand, comprises a rod-shaped coupling member 12 with a coupling head 11. The coupling member 12 is also mounted radially on one side in the turret of the preferred apparatus 1. In this context, the coupling member 12 is aligned such that the coupling head 11 points radially outwards. The coupling head 11 is preferably structurally adapted to a component of the turret of the tableting machine 2 (first turret [not shown in FIG. 2]). This enables the coupling head 11 to engage with the component of the turret of the tableting machine 2, such that a rotary movement of the turret of the tableting machine 2 can be transmitted to the turret of the apparatus 1. Preferably, the coupling head 12 exhibits the shape of a fork, which is preferably matched to the diameter of a shank of a lower punch 15 of the tableting machine 2, such that the fork can accommodate the shank of the lower punch 15.

The active connection between object holder 7 and coupling element 10 is configured in such a way that the gripper arm 13 is preferably connected to the coupling element 12 via a guide mechanism. The gripper arm 13 and the coupling element 12 are mechanically connected in such a way that a tangential and radial deflection of the coupling element 12 in relation to a rotary movement of the turret of the apparatus 1 can be transmitted directly to the gripper arm 13. The coupling member 12, the gripper arm 13 and the mechanical connection are also preferably mounted in the turret of the apparatus 1 according to the invention via a first spring element 17 and a second spring element 18 (see in particular FIG. 5), with the first spring element 17 preferably determining the radial starting position and the second spring element 18 determining the tangential mobility via the rigidity.

FIG. 3 shows a further schematic representation of the interaction between a preferred apparatus 1 and a preferred tableting machine 2, in particular the representation of the interaction between preferred coupling elements 10 and preferred shanks of lower punches 15. Each preferred coupling element 10 comprises a rod-shaped coupling member 12 with a coupling head 11, wherein the coupling member 12 is preferably mounted radially on one side in the turret of the preferred apparatus 1. The coupling member 12 is oriented such that the coupling head 11 points radially outwards. It is understood that a preferred tableting machine 2 exhibits at least one lower punch, comprising a shank 15, for the production of tablets. A lower punch (or also its shank 15) is preferably arranged in the turret of the tableting machine 2 in such a way that it rotates with it and can be inserted from the underside into a die 5 (not shown in FIG. 3) in a centered manner.

The turret of the tableting machine 2 (first turret) preferably rotates in the opposite direction to the turret of the apparatus 1 (second turret).

Preferably, the coupling head 11 exhibits the shape of a fork, which is preferably matched to the diameter of a shank of a lower punch 15 of the tableting machine 2, such that the fork can accommodate the shank of the lower punch 15. As soon as the shank of a lower punch 15 comes into contact with the coupling head 11, the coupling member 12 is entrained, wherein during entrainment the shank of the lower punch 15 presses the coupling head 11 and the coupling member 12 radially against the axis of rotation 9 of the second turret until the coupling member 12 reaches a minimum radial deflection. As described in connection with FIG. 2, the object holder 7 or the gripper arm 13 and the coupling element 10 or coupling member 12 are connected to each other via a guide mechanism, such that the object holder 7 or the gripper arm 13 performs the same radial movement (not shown in FIG. 3).

The proposed apparatus 1 also preferably exhibits a bearing for the coupling member 12, which restricts or prevents tangential movement in the minimum radial deflection. After the coupling member 12 has reached the minimum with respect to the radial deflection, the lower punch continues to rotate and continues to guide the coupling head 11 or the coupling member 12 with its shank 15 in a tangential direction. In the context of the invention, this is also referred to as engagement, wherein a rotary movement of the turret of the tableting machine 2 can be transmitted to the turret of the apparatus 1. The radial and tangential deflection of the coupling element 10 or coupling member 12 is also preferably to be regarded as a coupling movement. The tangential movement of the coupling element 10 or coupling member 12 is also preferably transmitted to the object holder 7 or the gripper arm 13 via the aforementioned guide mechanism.

FIG. 4 shows a three-dimensional view of a section of a preferred embodiment of the apparatus 1 according to the invention and of a preferred tableting machine 2. Preferably, a conventional rotary tableting machine can be used as a tableting machine 2, which is configured in particular to press single-layer or multi-layer tablets. The rotary tableting machine can be extended in an advantageously simple manner with the preferred apparatus 1 such that it can press a core or an object into the pellets to be produced. It is understood that at least one die 5 (not visible in FIG. 4) is arranged on a reference circle in a turret driven to rotate about a first axis of rotation 8 within the rotary tableting machine, while the preferred apparatus 1 comprises a second turret which rotates about a second axis of rotation 9. In the preferred embodiment, the axis of rotation 8 of the first turret (i.e. the turret of the tableting machine 2) is arranged substantially parallel to the axis of rotation of the second turret 9 (i.e. the turret of the preferred apparatus 1). In this respect, the second turret can advantageously be subsequently positioned in such a way that the preferred apparatus 1 is able to insert at least one object 6 (not shown in FIG. 4) into the at least one die 5. The apparatus 1 can thus preferably be provided as an additional module for rotary tableting machines.

The turret of the tableting machine 2 preferably rotates in the opposite direction to the turret of the apparatus 1. Furthermore, the coupling heads 11, which are each referred to together with a coupling member 12 as a coupling element 10, grip the shanks of the lower punches 15 of the tableting machine 2. The rotary movement of the turret of the tableting machine 2 is thus preferably transmitted to the turret of the apparatus 1. In addition, the coupling members 12 are preferably mechanically connected to the gripper arms 13 via a guide mechanism, such that the radial and/or tangential movement of the coupling element 10 or coupling member 12 (coupling movement) is transmitted to the gripper arm 13 via the guide mechanism (details of the connection of coupling member 12 and gripper arm 13 are shown in FIG. 5).

FIG. 5 shows a sectional view of a preferred embodiment of the apparatus 1 according to the invention. In particular, a guide mechanism is shown which is configured to bring an object holder 7 into active connection with a coupling element 10. The coupling element 10 can take up a coupling movement through contact (the contact process is preferably also referred to as engagement) with the first turret (turret of the tableting machine 2) and deflect the movement path 3 (not shown, see FIG. 1) of an object 6 (not shown, see FIG. 1) via the object holder 7 and the guide mechanism in a predetermined spatial direction, namely in the form of the coupling movement, radially and tangentially in relation to the rotary movement of the second turret (turret of the preferred apparatus 1).

The coupling element 10 preferably consists of a coupling member 12 and a coupling head 11, while the object holder 7 comprises a gripper arm 13 and a holding element 14. The coupling element 10 is preferably mounted on one side in the second turret, wherein the coupling element 12 is aligned in such a way that the coupling head 11 points radially outwards and is structurally adapted to a component of the first turret. The gripper arm 13 is provided with the holding element 14 (together to be regarded as object holder 7) and is preferably also mounted radially in the second turret, wherein the holding element 14 is preferably configured to hold the object 6 in a positively and/or frictionally connected manner. The gripper arm 13 is preferably mechanically connected to the coupling member 12 (guide mechanism) in such a way that a tangential and radial deflection of the coupling member 12 in relation to a rotary movement of the second turret can be transmitted directly to the gripper arm 13.

In this respect, the mechanical connection of gripper arm 13 and coupling member 12 preferably comprises a bolt 16, which is oriented substantially orthogonally to the horizontally aligned gripper arm 13 and coupling member 12, which are mounted radially in the second turret. The bolt 16 serves in particular to transmit forces from the coupling member 12 to the gripper arm 13 such that the movement of the coupling member 12 can be adapted by the gripper arm 13. The bolt 16 is preferably rigidly connected to the gripper arm 13 and the coupling member 12.

The coupling member 12, the gripper arm 13 and the mechanical connection (in particular the bolt 16) are also preferably mounted in the second turret via a first spring element 17 and a second spring element 18. In this context, the first spring element 17 preferably determines the radial starting position, while the second spring element 18 preferably determines the tangential mobility of the coupling element 12 and gripper arm 13 via the rigidity.

The first spring element 17 is preferably designed as a coil spring. Preferably, the coil spring engages in the mechanical connection, in particular on the bolt 16, such that the coupling member 12 and the gripper arm 13 are equally influenced by this spring. Since the first spring 17 is preferably preloaded, a force acts on the coupling element 12, the gripper arm 13 and the mechanical connection, in particular on the bolt 16, in the direction of their radial starting position.

It is understood that the coil spring guides the coupling member 12, the gripping arm 13 and the mechanical connection (in particular the bolt 16) in an initial position. During the engagement process, a force is applied to the coil spring in a radial direction via the coupling member 12, such that it is compressed and the coupling member 12, the gripper arm 13 and the mechanical connection, in particular the bolt 16, are displaced radially in the direction of the turret center.

Furthermore, the second spring element 18 is preferably a combination of a bending rod or bending beam 19 and a sleeve element 20, wherein the sleeve element 20 is preferably mounted in one degree of freedom on the bending rod or bending beam 19. The bending rod or bending beam 19 is mounted radially on the turret of the preferred apparatus 1, while the sleeve element 20 is preferably screwed to the coupling member 12 and accommodates the bending rod or bending beam 19. The sleeve element 20 is guided in a correspondingly movable manner over the bending bar or bending beam 19.

Preferably, the sleeve element 20 is attached to the end of the coupling member 12 facing the turret and the bending rod or bending beam 19 can be (partially) pushed out of the sleeve element 20. In the radial starting position of the coupling element 12, the bending bar or bending beam 19 is pushed out of the sleeve element 20 as far as possible such that it is bent as soon as a bending torque acts on it. During engagement, the coupling member 12 is subjected to a tangential force by the component of the tableting machine 2, preferably by the shank of a lower punch 15. This force generates a bending torque on the bending bar or bending beam 19 and causes bending, wherein the coupling member 12 can be pivoted tangentially. In addition, the bending rod or bending beam 19 is pressed radially into the sleeve element 20 during the gripping process of the coupling element 12, which makes bending more difficult until the bending rod 19 is completely inserted into the sleeve element 20 and bending is no longer possible. If the bending bar or bending beam 19 can no longer be bent, tangential movement of the coupling element 12 is also not possible. The tangential mobility is accordingly determined by the rigidity of the bending bar or bending beam 19. The more rigid the bending bar 19, the lower the tangential mobility of the coupling element 12 in the starting position, or the more force must preferably be applied to achieve the desired mobility.

Preferably, the holding element 14 is to be regarded as an embodiment of a holding means. The holding element 14 is preferably configured to pick up, hold and/or release the object 6. Furthermore, the holding element 14 is preferably configured to hold the object 6 for transportation over approximately half a rotation of the second turret and to release it into the die 5 in a region in which the movement path 3 of the object 6 intersects the movement path 4 of a die 5 (see also FIG. 1). Preferably, the holding element 14 can be activated/controlled sufficiently quickly to be able to pick up a fixed-position object 6 even at high rotational speeds of the second turret. Accordingly, the holding element 14 can be configured, for example, such that it exhibits a pincer that holds the object 6 in a frictionally connected manner. Alternatively, the holding element 14 can exhibit means that generate negative pressure and hold the object 6 in a frictionally connected manner. In this context, the gripper arm 13 is preferably configured such that it itself or, in particular, the holding element 14 can be adjusted in a height position so that the holding element 14 can precisely pick up and/or place the object 6. For example, the second turret exhibits guide cams 21. The holding element 14 is preferably connected to the guide cams 21 via transmission elements 22, with the transmission elements 22 guiding or force-controlling the holding element 14 to a height position. The guide cams 21 are preferably arranged circumferentially on the second turret, such that the holding element 14 is force-controlled or guided along these guide cams 21. Such guide cams 21 are also known, for example, in rotary tableting machines for guiding upper and lower punches

FIG. 6 illustrates a further sectional view of a preferred embodiment of the apparatus 1 according to the invention. In particular, the engagement of the coupling element 10 of the turret of the apparatus 1 is illustrated by the shanks of the lower punches 15 of the turret of the tableting machine 2. A coupling element 10 preferably comprises a rod-shaped coupling member 12 with a coupling head 11. Preferably, the coupling head 12 exhibits the shape of a fork, which is preferably matched to the diameter of a shank of a lower punch 15 of the tableting machine 2, such that the fork can accommodate the shank of the lower punch 15.

Furthermore, a gripper arm 13 is preferably connected to the coupling member 12 via a guide mechanism. The gripper arm 13 and the coupling member 12 are preferably mechanically connected in such a way that a tangential and radial deflection of the coupling member 12 in relation to a rotary movement of the turret of the apparatus 1 can be transmitted directly to the gripper arm 13. The coupling member 12, the gripper arm 13 and the mechanical connection are mounted in the second turret via a first spring element 17 and a second spring element 18 (not shown), with the first spring element 17 preferably determining the radial starting position of the coupling member 12 and the gripper arm 13. In addition, the turret of the apparatus 1 preferably exhibits guide cams 21, which guide a holding element 14 attached to the gripper arm 13 in a height position. The holding element 14 is actively connected to the guide cams 21 via transmission elements 22, wherein the transmission elements 22 guide or force-control the holding element 14 into a height position. The guide cams 21 are preferably arranged circumferentially on the second turret

FIG. 7 shows a three-dimensional view of a preferred embodiment of the apparatus 1 according to the invention, in particular a representation of the picking up of objects 6 by preferred object holders 7. For the insertion of objects 6 into dies 5 of a tableting machine 2, it is essential that a preferred object holder 7 first picks up an object 6 from an object reservoir.

For the purposes of the invention, the object holder 7 is preferably mounted radially in the turret of the preferred apparatus 1 and is able to pick up an object 6 from an object reservoir. Subsequently, the object holder 7 can transport the object 6 over a substantially half rotation of the second turret and finally deliver the object 6 preferably into a die 5 of the tableting machine 2. The object holder 7 and the die 5 as well as the two turrets of the preferred apparatus 1 and the tableting machine 2 are coordinated in such a way (in particular via the radial and tangential controllability of the object 6 or object holder 7) that the object 6 can be introduced into the die 5 in a precise position.

The object reservoir is preferably configured as a feeder, in particular a conveyor belt. With respect to the second turret, the object reservoir is preferably present approximately on the opposite side of the location at which the object 6 is introduced into the at least one die 5, such that the object holder 7 holds or transports the object 6 over approximately a 180° rotation of the second turret. The object holder 7 is preferably configured to pick up an object 6 individually and provide it to the die 5.

The coupling element 10 preferably has no function for picking up the object 6. However, there may be alternatives in which the coupling element 10 also picks up components from a feed unit, such as a transfer wheel, to pick up an object 6. Furthermore, as already stated in the above descriptions, the object holder 7 preferably comprises a gripper arm 13 with a holding element 14, wherein the holding element 14 is guided in height via transmission elements 22 and guide cams 21.

### REFERENCE LIST

1 Preferred apparatus
2 Tableting machine
3 Movement path of the at least one object
4 Movement path of the at least one die
5 Die
6 Object
7 Object holder
8 Rotational axis of the first rotationally driven turret
9 Rotational axis of the rotatable second turret
10 Coupling element
11 Coupling head
12 Coupling member
13 Gripper arm
14 Holding element
15 Shank of a lower punch
16 Bolt
17 First spring element
18 Second spring element
19 Bending bar or bending beam
20 Sleeve element
21 Control cam for guiding a height position
22 Transmission elements for guiding a height position

1. An apparatus for inserting at least one object into at least one die of a tableting machine, in which the at least one die is arranged on a reference circle in a driving first turret driven to rotate about a first axis of rotation;
wherein the apparatus comprises a second turret rotatable about a second axis of rotation;
wherein the second turret comprises at least one object holder, wherein the at least one object holder comprises holding means which enable the at least one object to be picked up, transported and released;
wherein a movement path of the at least one object can be controlled radially and tangentially in relation to rotary movement of the second turret via the at least one object holder, such that the movement path of the at least one object can imitate the movement path of the at least one die, at least over an angular range of rotation of the second turret.

2. The apparatus according to claim 1 wherein the second turret comprises a coupling element which is configured as follows, to initiate and/or ensure a rotary movement of the second turret via an active contact with the driving first turret;
to mechanically force-control the movement path of the at least one object by means of the at least one object holder at least over an angular range of rotation of the second turret.

3. The apparatus according to claim 2 wherein the at least one object holder is actively connected to the coupling element via a guide mechanism, wherein the coupling element can take on a coupling movement through the active contact with the first turret and the movement path of the at least one object can be deflected radially and tangentially in relation to the rotational movement of the second turret via the at least one object holder and the guide mechanism in a predetermined spatial direction, namely in the form of the coupling movement.

4. The apparatus according to claim 2, wherein the coupling element comprises a rod-shaped coupling member with a coupling head, wherein the coupling member is mounted on one side in the second turret, wherein the coupling member is aligned such that the coupling head points radially outwards and is structurally adapted to a component of the first turret, wherein the coupling head can engage with the component of the first turret, such that a rotary movement of the first turret can be transmitted.

5. The apparatus according to claim 4 wherein the coupling head comprises a fork which is matched to a diameter of a shank of a lower punch of the first turret, such that the fork can accommodate the shank of the lower punch.

6. The apparatus according to claim 1, wherein the object holder comprises a gripper arm with a holding element, which is mounted radially in the second turret.

7. The apparatus according to claim 6 wherein the gripper arm is mechanically connected to a coupling element in such a way that a tangential and radial deflection of the coupling element in relation to a rotary movement of the second turret can be transmitted directly to the gripper arm.

8. The apparatus according to claim 1, wherein the second turret comprises guide cams, which are configured to guide the holding means, which is comprised in the object holder, in a height position.

9. The apparatus according to claim 2, wherein the object holder and the coupling element are resiliently mounted in the second turret and can be guided into a radial starting position with respect to the rotation of the second turret via a spring preload, while the object holder and the coupling element can be pivoted tangentially with respect to the rotation of the second turret in the radial starting position.

10. The apparatus according to claim 9, wherein the object holder and the coupling element can be transferred to a pick-up position when the coupling element is in active contact with the first turret,
wherein the coupling element and a gripper arm have a greatest possible radial deflection and tangential mobility in the starting position, whereas the radial deflection and the tangential mobility in the pick-up position can continuously decrease to a minimum over an angular range of rotation of the second turret and then increase again to the radial starting position and the greatest possible tangential mobility.

11. The apparatus according to claim 1, wherein a coupling member, a gripper arm and a mechanical connection are mounted in the second turret via a first spring element and a second spring element.

12. The apparatus according to claim 1, wherein an angular range of rotation of the second turret, in which the movement path of the at least one object can be controlled radially and tangentially with respect to the rotational movement of the second turret via the at least one object holder, is at least 10°.

13. A system comprising:
a. a tableting machine comprising at least one die which is arranged on a reference circle in a turret driven to rotate about a first axis of rotation, and
b. the apparatus according to claim 1 for inserting at least one object into the at least one die of the tableting machine.

14. The system according to claim 13 wherein:
a. a coupling element of the second turret is in active contact with the driving first turret in order to initiate and/or ensure a rotary movement of the second turret;
b. the at least one object holder comprises holding means which enable the at least one object to be picked up, transported and released;
c. the movement path of the object intersects with the movement path of the die, wherein the movement path of the at least one object can be controlled radially and tangentially with respect to the rotational movement of the second turret, such that the movement path of the at least one object imitates the movement path of the at least one die at least over an angular range of rotation of the second turret, and the object holder is configured to release the at least one object into the die.

15. A method comprising using the apparatus of claim 1 for inserting at least one object into at least one die of a tableting machine.

16. The apparatus according to claim 2, wherein the object holder and the coupling element are resiliently mounted in the second turret and can be guided into a radial starting position with respect to the rotation of the second turret via a spring preload, while the object holder and the coupling element can be pivoted tangentially with respect to the rotation of the second turret in the radial starting position at an angle of up to 2°.

17. The apparatus according to claim 10, wherein a difference between an initial radial position and a minimum radial deflection is between 1 mm and 30 mm.

18. A method comprising using the system of claim 13 to insert at least one object into at least one die of a tableting machine.

19. The apparatus according to claim 1, wherein the first spring element determines a radial starting position, while the second spring element determines a tangential mobility via a rigidity.
